(19) United States
(12) Patent Application Publication
(10) Pub. No.: US 2013/0208315 A1
(43) Pub. Date: Aug. 15, 2013

(54) Generating Workflow Sequences for Print Jobs

(71) Applicants: Jun Zeng, Sunnyvale, CA (US); I-Jong Lin, Half Moon Bay, CA (US); Fabio Giannetti, Los Gatos, CA (US)

(72) Inventors: Jun Zeng, Sunnyvale, CA (US); I-Jong Lin, Half Moon Bay, CA (US); Fabio Giannetti, Los Gatos, CA (US)

(21) Appl. No.: 13/825,567

(22) PCT Filed: Oct. 1, 2010
(86) PCT No.: PCT/US10/51025

§ 371 Date: Mar. 22, 2013

(51) Int. Cl. G06F 3/12

(52) U.S. Cl. CPC G06F 3/1296
USPC 358/1.15

(57) ABSTRACT

A method separates a print job into a print product and a sequence of tasks. The method estimates a time to setup a machine before executing a task and a time for the machine to execute the task. Machines are identified that have a potential bottleneck due to multiple concurrent printing requests being made to a machine. A workflow sequence is generated to complete the print job.

### FIELD OF THE INVENTION

The present invention relates to generating workflow sequences for print jobs.

### BACKGROUND

Despite the “electronic age,” there is still demand for print services. Commercial print has annual retail sales over US$700B. Print service providers (PSPs) fulfill the demand for print services by printing a variety of articles, such as photographs, brochures, course materials, periodicals and books, advertisements, and product packaging.

The fulfillment of the print services is to convert print jobs of customers into printed products that are shipped to the customers. This process is complex and involves many different automated and manual steps that cannot be cost effectively treated as a standard manufacturing activity. For instance, a print production facility adapted to print and bind books includes many different types of machines and electronic equipment. This results in numerous combinations of factory configurations and workflows which may not be efficiently designed for optimal print performance.

### BRIEF DESCRIPTION OF THE DRAWINGS

FIG. 1A is a diagram of a print production system according to an example implementation.

FIG. 1B is a flow diagram of the print production system of FIG. 1A producing a product in accordance with an example implementation.

FIG. 2 is a flow diagram for print production planning according to an example implementation.

FIG. 3 is a diagram of a fulfillment process of a print product in which the fulfillment process is separated into a series of nine different tasks with a pre-defined precedence sequence according to an example implementation.

FIG. 4 is an optimization algorithm to provide sequencing and assignment solutions for print production planning according to an example implementation.

FIG. 5 shows a computer system in accordance with an example implementation.

### SUMMARY OF THE INVENTION

One example embodiment is a method that separates a print job into a print product and a sequence of tasks. The method estimates a time to setup a machine before executing a task and a time for the machine to execute the task. Machines are identified that have a potential bottleneck due to multiple concurrent printing requests being made to a machine. A workflow sequence is generated to complete the print job.

### DETAILED DESCRIPTION

Example implementations are systems, methods, and apparatuses for production planning, such as planning in print production and workflows. An example embodiment generates an operational sequence of accepted jobs according to one or more business objectives (for instance, maximize service-level and profit) and assigns the sequence of the jobs to one or servers, printers, or machines. The jobs are classified, for instance, according to their due date tightness, and the servers are classified according to service demand. An optimization algorithm that can be massively parallelized is implemented on a graphical process unit (GPU) to provide a solution in real-time. Example embodiments are implemented as a component of a work-flow solution or as a component of an operational planning tool, such as a print production planning tool.

One example embodiment relates to print manufacturing that is a make-to-order process. A print manufacturer or print service provider receives a print order of a customer and converts this order into a shipped print product, such as books, periodicals, calendars, stationeries, etc. Service level objectives (SLOs) for the print order include one or more of a completion time, costs for print production, and other constraints. One business objective of the print service provider is to increase the throughput of print jobs to dilute fixed costs and maximize profit while satisfying SLOs and a desired quality of service.

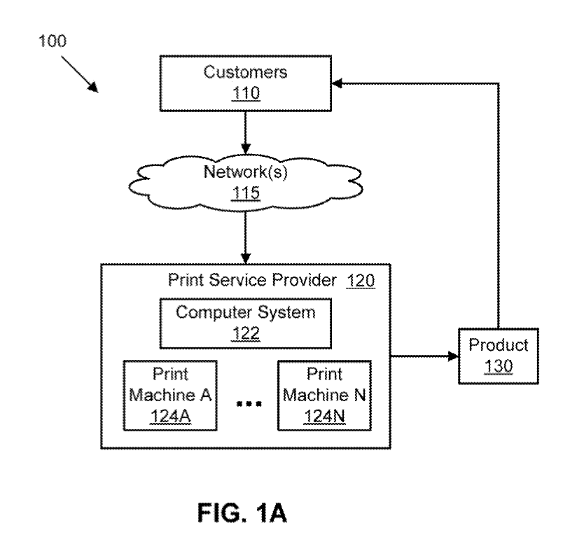

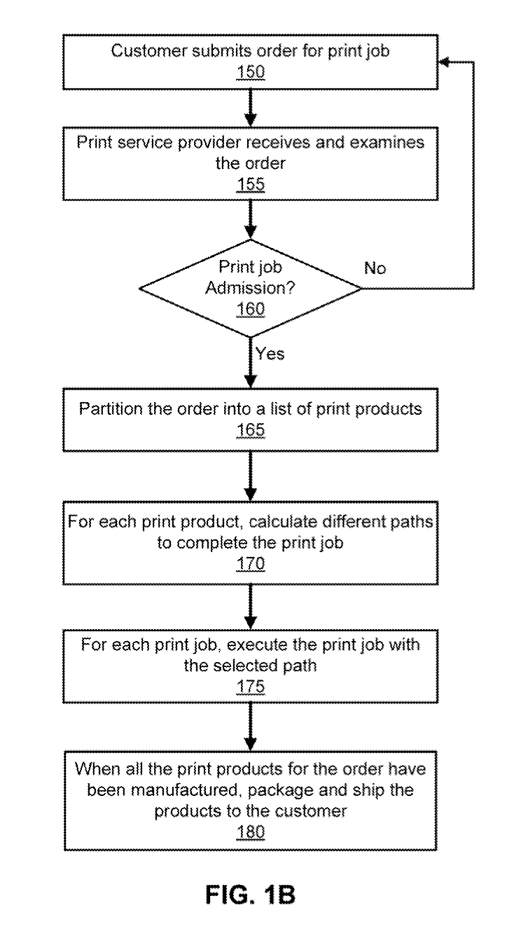

FIG. 1A is a diagram of a print production system 100 according to an example implementation. FIG. 1B is a flow diagram of the print production system 100 producing a product in accordance with an example implementation. These two diagrams are discussed together and illustrate an end-to-end workflow of a print manufacturing process for a print service provider 120.

According to block 150, a customer submits an order for a print job or submits a request for prints (e.g., submits a request for prints of a book).

For instance, one of the customers 110 provides the print job through one or more networks 115 to a print service provider 120. By way of illustration, the print job is provided through a store front (e.g., a customer physically visits a location to place the request or electronically submits the request through the internet).

According to block 155, the print service provider receives and examines the order for the print job.

According to block 160, a determination is made as to whether print job is accepted or admitted. If the print job is admitted, then flow proceeds to block 165. If the print job is not admitted, then flow proceeds back to block 150.

After the print job is received and accepted, a unique job ticket is assigned to the print job. The job ticket includes a job number, number of copies, due dates, prices and payments, client information, inks and presses, finishing, shipping methods, etc. Further stipulations can be provided as SLOs in a service level agreement (SLA).

Although not typically well-suited to an individual, the PSP may function to process print jobs for multiple individuals, such as, the customers of a large retailer, wherein the large retailer takes orders from the individuals (e.g., for photo calendars) and submits an order as a batch of individual customer orders to the PSP. For example, the customer is a large retailer submitting the order on behalf of many individuals. Of course the systems and methods described herein are not limited to any particular type or size of customer or customers, and may also be utilized with individual customers of the PSP. In general, the customer creates the material to be printed (e.g., the photographs and brochures, course materials, periodicals and books, to advertisements and product packaging) or works with a third-party provider to generate the material to be printed. The customer then submits an order including one or more materials for the PSP to print, along with one or more print parameters (e.g., substrate stock, number of copies, due date, and any special instructions such as laminating and quality level, and shipping information).

The submitted print job (e.g., submitted as electronic files in the form of Portable Document Format (PDF) and/or a Tagged Image File Format (TIFF)) are examined for correctness (preflight), edited for color quality and accuracy, imposed, and flattened and half-toned (raster imaging process) to create bitmaps.

According to block 165, the accepted order is partitioned into a list of different print products. A “print job” typically include, but is not limited to, a list, of items t to instruct the print operations, for instance, book titles, number of copies, and some or all of the print parameters from the order, and an expected due date. In addition, the PSP may assign additional priority information, for instance, the characterization of the customer, e.g., a repeat and high-volume customer may receive a higher priority from the PSP 100 than a first-time or low-volume customer. The print job may also include other parameters assigned by the PSP, for example, based on current backlog, supplies in stock, and so forth.

An order an be a Job Definition Format (JDF) file initiated during a content creation stage. The order can also be in other forms of Extensible Markup Language (XML), Personalized Print Markup Language (PPML) file format, or another format negotiated between the print service provider and their upstream digital content provider. The order describes complete fulfillment specifications in addition to other information. These specifications are then used in a print manufacturing environment of the print service provider 120 to produce and ship the final printed product. Customer information includes shipping and payment and provides a financial measurement of late penalty (e.g., costs to upgrade a shipping method to compensate for a manufacturing delay).

According to block 170, for each print product, different or alternate paths are calculated to complete the print job. For example, the print job request is analyzed by a computer system 122 to find different workflow paths for completing the print job at the print manufacturing facility.

One example embodiment provides quantitative prediction, analysis, and operational-level assistance for the print manufacturing process. This includes determining different production paths through the print manufacturing facility to produce the product. For example, one example embodiment narrows the fulfillment to a handful of product types that contribute to revenue according to past order history and marketing forecast. A list of product types is then used to guide the optimization of the factory floor and order admission. Each product type has its pre-defined fulfillment path; resources are shared among different fulfillment paths when optimal. The fulfillment paths are further augmented with a list of resources that map the tasks demanded by the fulfillment paths with one or more of software, automated machines (e.g. printing machines), operator-assisted machines, hardware, and operators that carry out the respective tasks.

Multiple orders released to the factory floor for simultaneous production compete for resources. Priorities for services are provided to urgent orders (e.g., priority is based on a deadline specified in a SLA). An order sequence is calculated based on the priorities. Similarly there may be multiple machines that can fulfill the same task. Here, priorities for the task assignment are given to the most effective machines orders (e.g., calculate the effectiveness of a printing machine according to the operations objective and attributes and states of the printing machine).

According to block 175, each print job is executed with a selected one of the paths or workflows. Here, the print job is sent to one or more servers or print press or finishing machines 124A-124N. For example, printer-ready electronic files are sent to print presses to produce physical copies. Printed sheets or web are divided into printed pages that are then folded, collated, and bound into book blocks, if the final product is a book. The book blocks are joined to book covers. The print machines 124A-124N refer to all machinery, resources, and procedures used to complete the print product, including print presses, cutters, laminators, binders, shipping stations, and more.

According to block 180, a final product 130 is shipped from the print service provider 120 to the customer 110 once all the print products within the same order have been collected. For example, if the print products are books, then the finished books are sorted. When all the printed books for this order are collected, they are packaged together. The package is labeled according to shipping instruction, for instance, shipped by Federal Express or U. S. Post Office. The labeled package is then placed at the shipping station for the shipper for instance, DHL, Federal Express) to pick up.

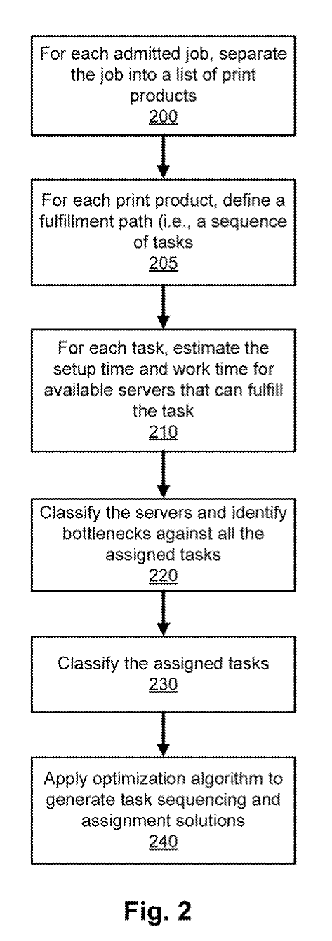

FIG. 2 is a flow diagram for print production planning according to an example implementation. One or more of these blocks can be performed by the print service provider 120 shown in FIG. 1.

According to block 200, for each admitted job, the job is separated into a list of print products. For example, an admitted order may include two copies of three different book titles therefore six print products. Next, the manufacturing procedure of each print product is separated into a sequence of tasks, such as raster image processing (RIP), black and white printing, case binding, kitting, shipping, etc.

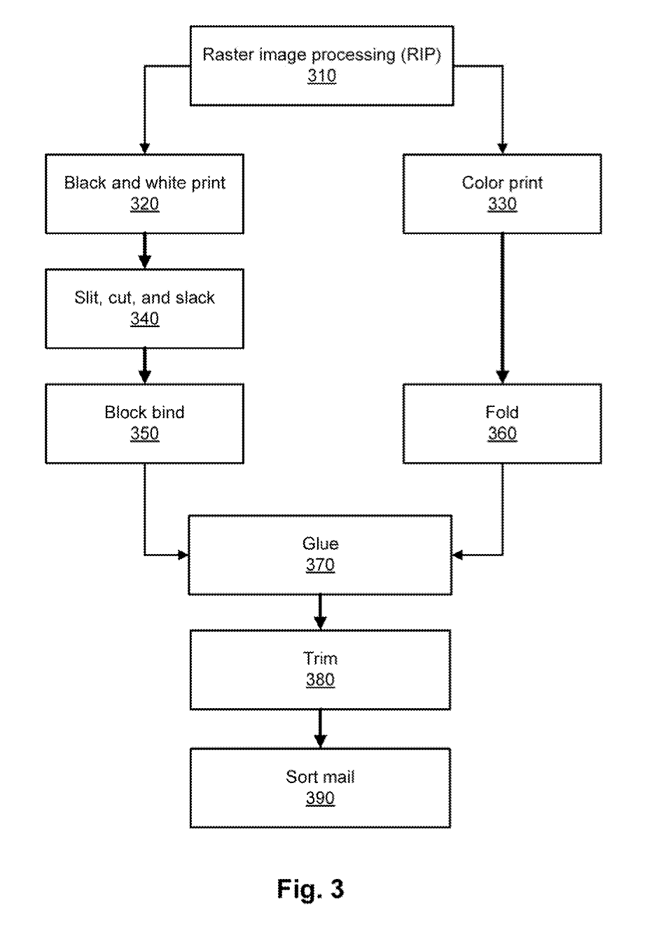

As used herein, a task is defined as work that can be completely fulfilled by a unit of one server type, for instance, one print press out of the array of print presses on the factory floor. For each job, the sequence of tasks has precedence constraints that certain tasks must be executed or carried out before other tasks, for instance, in FIG. 3, RIP 310 must be accomplished before prints 320, 330.

This task sequence can be predefined by a set of workflow templates, for instance, transactional, periodical, books, photobooks, publications, and then the accepted job is then assigned to the corresponding workflow template.

According to block 205, for each print product, the method defines a fulfillment path (i.e., a sequence of tasks).

FIG. 3 is a diagram of a fulfillment process or a print production job 300 of a print product in which the fulfillment process is separated into a series of nine different tasks with a pre-defined precedence sequence according to an example implementation. For example, the print production job creates a book having black and white printed pages with a color cover.

Raster image processing 310 generates a raster image or bitmap that is sent to a black and white printer 320 and a color printer 330. The black and white printer 320 prints the internal pages of the book, and the color printer 330 prints the cover and/or color pages. At block 340, slit, cut, and collating operations occur, and at block 350, the block is bound (i.e., makes part of the book block). At block 370, glue operations occur (e.g., pages of the book are glued together at the binding). At block 380, trim operations occur. At block 390, this book is packaged, labeled and mail-sorted.

Turning back to FIG. 2, according to block 210, the method estimates for each task both the setup time and the work time for available servers (e.g., all servers able to complete this particular task). For example, the setup time is sequence dependent (i.e. the setup time depends on the characteristic of the task processed by this server prior to this task). To account for this sequence dependency, a common baseline is defined for similar tasks or a same family of tasks. For each task, the recorded setup time is that time that assumes the baseline is the task processed in a prior print job. For instance, assuming the setup times for tasks A, B, C are 5, 15, 10 measured from the baseline, then for job sequence {ABC}, the setup cost is {5,10,5}; for job sequence {ACB}, the setup cost is {5,5,5}. This job sequence minimizes the setup cost for the given tasks A, B and C. Additionally, the due date tightness (e.g., SLACK time, defined as (due date—work time—release date)) for each task is estimated.

One example embodiment estimates the workload (e.g., work that can be completed by one print production machine). For example, this estimate includes the workload that can be completed by plural different printing machines that can be used to complete the print job. This workload includes both variable costs (e.g., the number of pages to be printed) and fixed costs (for example, setup cost, e.g., cost to load a paper roll in a printing machine). Reducing the fixed cost helps to improve the manufacturing throughput and reduced the lead time, which increases customer satisfaction. For example, assume a particular job to be printed requires printing on a particular substrate, for instance, cream paper. Further assume that machine press A already has the cream paper roll loaded, but machine press B has the white paper roll loaded. One example embodiment chooses machine press A over machine press B so the job can be completed without the overhead of offloading and loading paper roll. If press B were chosen, a person would need to unload the currently-loaded white paper roll, and then reload the cream paper roll. Thus, one embodiment estimates a fixed cost that includes determining whether the print job can be started and completed by the printing machine without loading paper into the print press.

According to block 220, the method classifies the servers into server types and identifies bottleneck server types. Here servers refer to a software server, a machine, or a worker that can completely fulfill a single task. For example, the print presses that are capable of printing black-and-white pages are grouped into one server type. The utilization rate of each sever type represents the ratio of the demand for the service of this particular server type over the capacity of this particular server type. For instance, this utilization rate can be determined as the ratio of the busy time over total available working time during a particular time interval, for instance, a week. The busy times and the total available working times can be extracted from past historical factory record. The server type holds highest utilization rate is called the resource bottleneck. That is, this particular server type is the scarcest resource of the entire print manufacturing workflow because its service demand is closest to its maximum capacity. All the server types are placed into a server type queue. This server type queue is sorted according to the utilization rate in the descendent order. Therefore, the first element in this server type queue has the highest utilization rate therefore the resource bottleneck.

The task sequencing and assignment procedure starts with the resource bottleneck server type. Once all the assignment is done with this resource bottleneck, this server type will be deleted from the server type queue. The first element of current server type queue is the bottleneck among all yet-to-be-scheduled resource types. We now schedule the tasks of this service type. Once the scheduling is done, this server type will be deleted from the server type queue. We repeat this procedure until the server type queue is empty, that is, all the server types have been scheduled. This way the degree of usage optimization of server types are aligned with their order of the scarceness.

By way of example, consider a print factory that produces only booklets. The fulfillment path starts with RIP, followed by PRINT, BINDING and MAILING. There are 2 RIP servers, 2 print presses, 6 binders of different generations, and one mail-sort station. Therefore there are four server types. For instance, all 6 binders form one “binder” server type. Historical record shows 70% of the time the two print presses are busy printing pages. Therefore, the utilization rate for the “print” server type is 70%. Historical record also shows RIP servers 50% of utilization rate, binder servers 40% of utilization rate, and the mail-sort station 45% utilization rate. Therefore, the server type queue will consist of PRINT, RIP, MAIL, and BINDER, following the descendent order of the corresponding utilization rate. PRINT will be the bottleneck to be first scheduled, and it is removed from the server type queue afterwards. Next is to schedule the first element of the remaining server type queue, which is RIP; repeat for MAIL; and perform BINDER last. It should be noted that the servers within the same server type may have different capacity, capability and availability even though they can fulfill the same task. For instance, the 6 binders are of different generations, some can be newer than others and hence have different performance characteristics (e.g., binder A is newer than binder B and binds more booklets per minute). With block 220, example embodiments classify each server on the floor of the factory. This process is a resource classification procedure.

For each server type, according to block 230. its corresponding tasks are classified. Task classification is according to the task's priority. The priority of a task can be calculated according to its lead time, its due date, and other operating parameters. In one embodiment, the priority of a task equals to its due date. In another embodiment, the priority of a task equals to the difference between the due date and the lead time (that is, time required to complete this task). In another embodiment, the PSP assigns all jobs from a repeat and high-volume customer an additional weight factor to elevate their priority. In another embodiment, the PSP assigns all high-value jobs (jobs with higher margin rate) an additional weight factor to elevate their priority. Tasks according to their priority values are assigned to different task bins. The tasks within the highest priority bin are scheduled first, and then the tasks within the second highest priority bin. This is repeated until all the tasks are scheduled.

According to block 240, an optimization algorithm is applied to generate a sequence for the task and assignment solutions.

For the selected server type (performed at block 220, there may be multiple servers that can complete the same task but have different capability, capacity and availability) and the corresponding selected task class (performed at block 230, there may be multiple tasks competing the same type of resources), an optimization algorithm is applied to generate the assignment of tasks to each server within this server type, and the order that tasks will be performed by each server.

By way of example, consider the aforementioned print factory that produces booklets. There are 20 binding tasks to be assigned to the binder server type with 6 binders. These 20 binding tasks can be partitioned into three task bins according to their priority value, Bin A, B and C. Tasks in bin A belong to the highest-priority category; tasks in bin C belong to the lowest-priority category. The assignment starts with assigning all tasks in bin A to all the 6 binders. In one embodiment, this assignment is carried out by an optimization algorithm to maximize the operations objective, for instance, load balancing among different servers, or, minimize lead time for tasks of high priority. Next, this optimization algorithm creates assignment solutions for tasks in bin B. Following that is the assignment for tasks in bin C.

One example embodiment finds task sequences and binding tasks with an optimal choice of the candidate servers. Brutal-force optimization techniques (e.g., mixed integer programming) can be applied; but they may not be able to satisfy the real-time constraints (in-line solution) due to the hyper polynomial computational cost. As such, one embodiment executes an algorithm that is a hybrid of a Genetic Algorithm and Simulated Annealing that provides massive parallelizability so that it can be implemented on graphical process unit (GPU) architecture to deliver real-time performance. This hybrid also overcomes the traps of local minima/maxima thanks to the features adapted from simulated annealing.

One example embodiment is a method that obtains a print job that requires plural different servers to execute. The method estimates times for different sequences of the servers to execute the print job and identifies potential bottlenecks among all sever types involved in the workflow. The method then analyzes the times for the different sequences and the potential bottlenecks and selects one of the different sequences to execute the print job. For example, an optimal sequence is selected (e.g., one having the optimal lead time distribution for all the print jobs, that is, achieving the maximal on-time delivery).

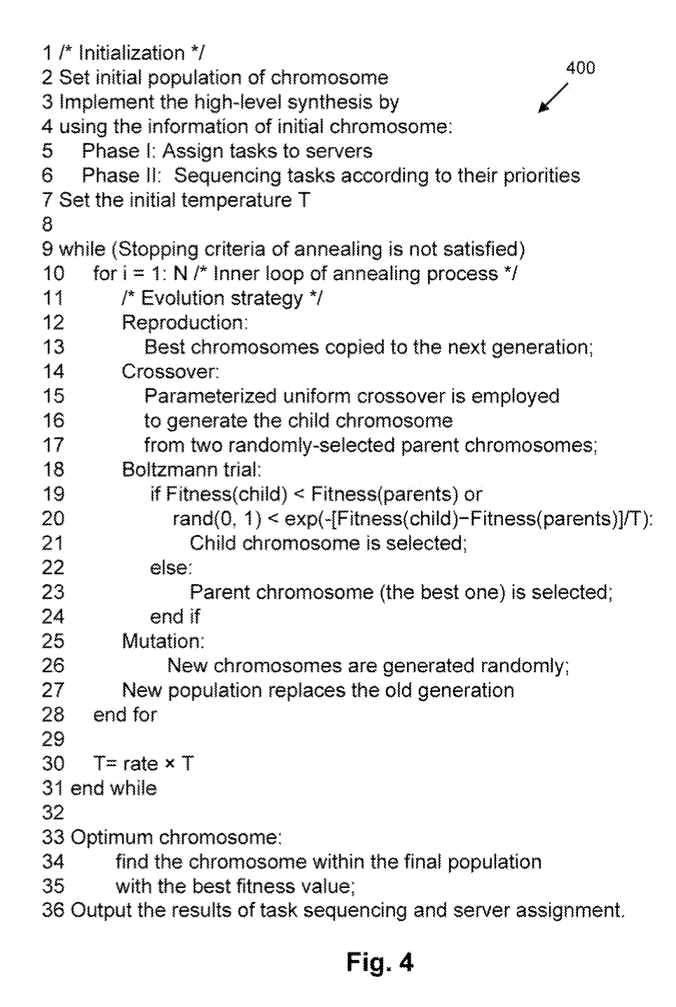

FIG. 4 shows an optimization algorithm 400 to provide sequencing and assignment solutions for print production planning.

One example embodiment executes a Parallel Recombinative Simulated Annealing (PRSA) algorithm. A PRSA fitness function is a weighted combination of multiple objectives, including take time (i.e., maximum time per unit to produce a product to meet a specified demand), makespan (i.e., the time difference between the start and finish of a sequence of jobs or tasks), service level, cost-per-page, etc.

An alternative embodiment is to eliminate the outer loop (block 220 in FIG. 2) to simplify the calculation. For the bottleneck sever type, the task sequencing and binding is carried out. For all other server types, the task sequence is determined such that the jobs maintain the same order as the bottle neck server type.

Example embodiments provide methods and apparatus that enable the delivery of in-line planning solutions that are applicable to both job-shop and flow-shop configurations. As a component of a planning tool, example embodiments identify additional productivity and optimal job mixes that maximize profit subject to acceptable service levels and help to allocate resource investment strategies that maximize return. As a component of an in-line production management tool, example embodiments provide real-time sequencing and resource binding solutions for accepted jobs to achieve (pareto)-maximum of service-level and profit.

Example embodiments are implemented in various apparatus and methods that provide operational level planning assistance accounting for job assignment and sequencing, such as being a component of print production planning software or a component of a work-flow solution,

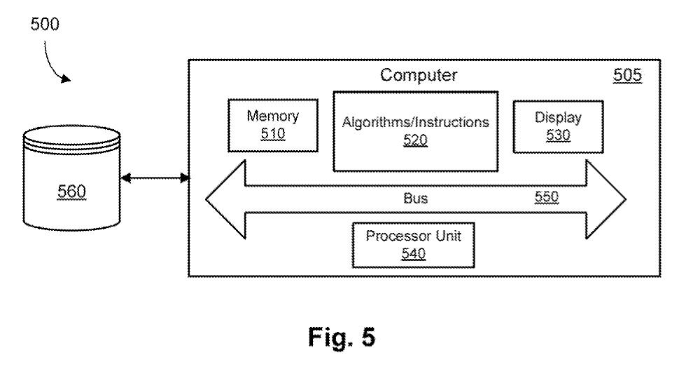

FIG. 5 is a block diagram of a computer system 500 in accordance with an exemplary embodiment of the present invention. By way of example, the computer system is implemented by a print service provider or in a print production facility.

In one embodiment, the computer system includes a database or warehouse 560 and a computer or electronic device 505 that includes memory 510, algorithms and/or computer instructions 520, display 530, processing unit 540, and one or more buses 550.

In one embodiment, the processor unit includes a processor (such as a central processing unit, CPU, multi-core CPU, microprocessor, GPU, application-specific integrated circuit (ASIC), etc.) for controlling the overall operation of memory 510 (such as random access memory (RAM) for temporary data storage, read only memory (ROM) for permanent data storage, and firmware). The processing unit 540 communicates with memory 510 and algorithms 520 via one or more buses 550 and performs operations and tasks necessary for constructing models and searching the database per a query. The memory 510, for example, stores applications, data, programs, algorithms (including software to implement or assist in implementing embodiments in accordance with the present invention) and other data.

In one example embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision

The methods in accordance with example embodiments are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit example embodiments,

In some example embodiments, the methods illustrated herein and data and instructions associated therewith are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

Example embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The software programming code, for example, is accessed by a processor or processors of the computer or server from long-term storage media of some type, such as a CD-ROM drive or hard drive. The software programming code is embodied or stored on any of a variety of known physical and tangible media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, an physical media, and/or distributing software code via networks are well known and will not be further discussed herein.

The above discussion is meant to be illustrative of the principles of various example embodiments. Numerous variations and modifications will become apparent to those skilled in the art once the above disclosure is fully appreciated. It is intended that the following claims be interpreted to embrace all such variations and modifications.

What is claimed is:

1) A method executed by a computer, comprising:
separating, by the computer, a print job into print products;
separating, by the computer, each of the print products into a sequence of tasks;
estimating, by the computer and for multiple machines capable of completing the tasks, a time to setup a machine before executing a task and a time for the machine to execute the task:
identifying, by the computer, machines having a potential bottleneck due to multiple concurrent printing requests being made to one of the machines; and
generating a workflow sequence to complete e the print job.

2) The method of claim 1, wherein the time to setup a machine is derived from a common baseline that defines similar tasks previously processed by the machine for a prior print job.

3) The method of claim 1 further comprising, estimating a workload that can be completed by plural different servers used to complete the sequence of tasks.

4) The method of claim 1 further comprising, estimating a fixed cost that includes determining whether the print job can be started and completed by a printing machine without loading paper into the printing machine.

5) The method of claim 1, wherein the print job is an order to produce books, and an optimization algorithm selects a sequence of the machines to print pages of the books, fold and glue bindings of the books, and assembly and bind the print pages into the books.

6) A tangible computer readable storage medium storing instructions that, when executed by a computer, cause the computer to:
obtain print jobs that require plural different servers to execute;
separate each of the print jobs into a list of print products and each of the print products into a sequence of tasks;
estimate for each of the tasks, times for different sequences of the servers to execute the print jobs;
identifying potential bottlenecks at each of the servers according to usage demand in reference to capacity; and
analyze the times for the different sequences and the potential bottlenecks to select one of the different sequences to execute the print jobs.

7) The tangible computer readable storage medium of claim 6 herein the computer further executes the instructions:
calculate, for each task to be assigned to a bottleneck server type, a priority value that is based upon one of due time, lead time, and preferential customer;
categorize the tasks into different priority classes;
apply an optimization algorithm to generate an optimal assignment of the tasks to the servers within a server type; and
produce an end-to-end production sequence and assignment for a print service provider for the print jobs to be fulfilled.

8) The tangible computer readable storage medium of claim 6 wherein the computer further executes the instructions to rank the print jobs according to due dates provided in a service level agreement (SLA).

9) The tangible computer readable storage medium of claim 6, wherein the computer further executes the instructions to execute a Parallel Recombinative Simulated Annealing (PRSA) algorithm to select a task assignment solution to execute the tasks.

10) The tangible computer readable storage medium of claim 6, wherein the computer further executes the instructions to estimate, for each of the plural different servers, a time to setup a server before executing the print jobs and a time to complete the print jobs.

11) A computer, comprising:
a memory storing instructions; and
a processor that executes the instructions to:
retrieve print jobs that require plural different servers to execute;
separate each of the print jobs into a list of print products;
separate each of the print products into a sequence of tasks;
estimate, for each of the tasks, a time to setup a server before executing a task and a time for the server to execute the task for servers that are capable of completing the task;
identifying potential bottlenecks at each of the servers according to usage demand in reference to capacity; and
analyze setup times at the servers, completion times at the servers, and the potential bottlenecks to select a sequence of servers to execute the print jobs.

12) The computer of claim 11 wherein the processor further executes the instructions to consider multiple objectives that include take time at the servers, makespan, cost-per-page to print pages of the print jobs.

13) The computer of claim 11, wherein the print jobs area request to print produce copies of a book.

14) The computer of claim 11 wherein the sequence of tasks include raster image processing (RIP), black and white printing, color printing, block binding, and gluing pages to a binding.

15) The computer of claim 11 wherein the processor further executes the instructions to estimate a time for each of the servers to execute a portion of the print jobs.
